(19) United States
(12) Patent Application Publication
(10) Pub. No.: US 2008/0230296 A1
(43) Pub. Date: Sep. 25, 2008

(54) Front to Rear Torque Vectoring Axle with Overspaced Capability for Vehicle Dynamic Control Systems

(75) Inventor: Mircea Gradu, Massillon, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: THE TIMKEN COMPANY, South Canton, OH (US)

(21) Appl. No.: 11/997,771

(22) PCT Filed: Aug. 8, 2006
(86) PCT No.: PCT/US06/31143

§ 371 Date: Feb. 4, 2008

Related U.S. Application Data
(60) Provisional application No. 60/706,828, filed on Aug. 9, 2005.

(51) Int. Cl. B60K 17/35

(52) U.S. Cl. 180/249

(57) ABSTRACT

A torque bias coupling (50) for proportionally transferring driving torque to a rear secondary axle (18) of a front wheel drive based all-wheel-drive vehicle platform includes a double-planetary gear set (54) organized about a common axis (X) and a magnetic particle brake (56). The magnetic particle brake (56) is operatively coupled to a planet carrier (62) of the double-planetary gear set (54) to selectively apply a rotational reaction force there to. Regulation of the rotational reaction force enables selective transfer of torque from the vehicle driving motor (6) to the rear secondary axle (18) via the torque bias coupling (50). The configuration of the double-planetary gear set (54) enables the secondary rear axle (18) to be driven in an over-speed condition relative to the front primary axle (14) in order to improve vehicle dynamics.

### CROSS-REFERENCE TO RELATED APPLICATIONS

The present application is related to, and claims priority from, U.S. Provisional Patent Application Ser. No. 60/706,828 filed on Aug. 9, 2005, and which is herein incorporated by reference.

### TECHNICAL FIELD

The present invention relates generally to axle centers for automotive vehicles and in particular to a rear secondary axle for use in a front wheel drive-based All Wheel Drive vehicle platform having the capacity to vary and control torque transmitted from the vehicle engine to the vehicle wheels, as well as to drive the rear axle in an over speed condition relative to the front axle.

Automotive vehicles have their road wheels arranged on axles, with the wheels of any given axle being generally aligned across the width of the vehicle. When the wheels of a single axle are utilized to drive the vehicle, they are coupled to individual axle shafts which are, in turn, are coupled to a transmission mechanism of the vehicle through an axle center assembly. Normally the axle center assembly contains a differential unit which distributes torque to both wheels of the axle, but allows one wheel to rotate at a different velocity than the other, so that the vehicle can negotiate turns. As a vehicle turns, the wheel on the outside of the turn must turn faster than the wheel on the inside. The typical differential unit does not provide any control over the distribution of torque between the wheels of the axle.

In all-wheel drive vehicles, in which the wheels of two or more axles are utilized to drive the vehicle, a similar problem exists. In such a vehicle, the wheels of the front axle and the wheels of the rear axle each have torque delivered to them from the driving engine, often with little control over how the torque is distributed between the front and rear axles. Some all-wheel drive vehicles have an arrangement of clutches for controlling the distribution of torque between the front and rear axles, but these clutches are complex, relatively large and heavy, and require complex controls.

Accordingly, it would be advantageous to provide an axle center assembly for facilitating controlled torque distribution between the axles of an all-wheel drive vehicle, and which does not require complex controls and bulky clutch arrangements.

### SUMMARY OF THE INVENTION

The present invention resides in an axle center assembly which includes a torque coupling between the front and rear axles through which the torque for driving the vehicle wheels passes. The torque coupling contains a double planetary gear set and a brake which are coupled together between a input (prop) shaft and an output (pinion stem) shaft. The double planetary gear set facilitates control of torque transfers through the torque coupling, and enables the pinion stem to rotate in a over-speed condition relative to the prop shaft.

The foregoing features, and advantages of the invention as well as presently preferred embodiments thereof will become more apparent from the reading of the following description in connection with the accompanying drawings.

### BRIEF DESCRIPTION OF THE DRAWINGS

In the accompanying drawings which form part of the specification:

FIG. 1 is a schematic view of an automotive vehicle provided with an axle center assembly constructed in accordance with an embodiment the present invention;

FIG. 2 is a sectional view of an axle center assembly constructed in accordance with the present invention;

FIG. 3 is an diagrammatic view of a torque coupling forming part of the axle center assembly of FIG. 2;

FIG. 4 is a perspective view of the axle center assembly of FIG. 2; and

FIG. 5 is an perspective end view of the axle center assembly of FIG. 2, with the magnetic particle brake removed for illustration purposes.

Corresponding reference numerals indicate corresponding parts throughout the several figures of the drawings.

### BEST MODE FOR CARRYING OUT THE INVENTION

The following detailed description illustrates the invention by way of example and not by way of limitation. The description enables one skilled in the art to make and use the invention, and describes several embodiments, adaptations, variations, alternatives, and uses of the invention, including what is presently believed to be the best mode of carrying out the invention.

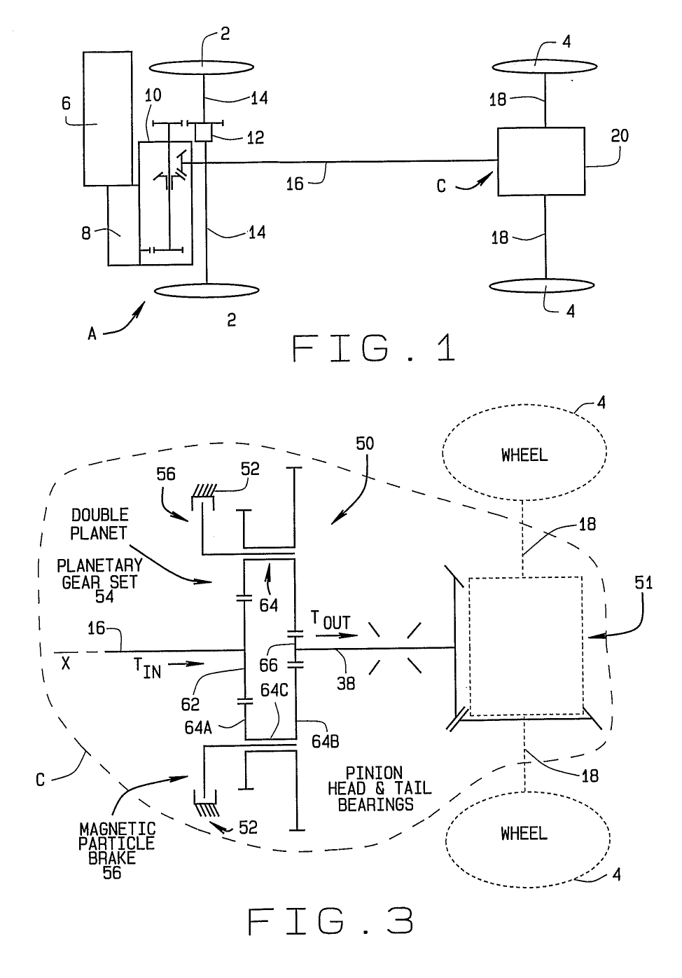

Referring now to the drawings, and to FIG. 1 in particular, an automotive vehicle A includes a set of primary wheels 2 at the front of the vehicle A and another set of secondary wheels 4 at the rear of the vehicle A. The vehicle A may include a motor 6 or other driving means which delivers torque to a transmission 8 which has the capacity to modify the torque for delivery through a transfer case or power take-off unit (PTO) 10 to both sets of wheels 2 and 4.

The transfer case or PTO 10 distributes the delivered torque from the transmission 8. A portion of the torque which is delivered to the primary wheels 2 passes through a differential 12 and on to the wheels 2 through axle shafts 14. The remaining portion of the torque originally delivered to the transfer case or PTO 10 is routed to the secondary wheels 4, via a drive shaft 16 to an input means of an axle center assembly C and on to the wheels 4 through axle shafts 18. The drive shaft 16 may be of unitary construction, or may consist of any number of shaft segments coupled together in a conventional manner. The axle center assembly C controls the distribution of torque between the wheels 2 and the wheels 4 by the transfer case or PTO 10. In addition to regulating the torque distribution, the axle center assembly C enables the rear wheels 4 to be driven in an over speed condition (i.e., faster) relative to the front wheels 2.

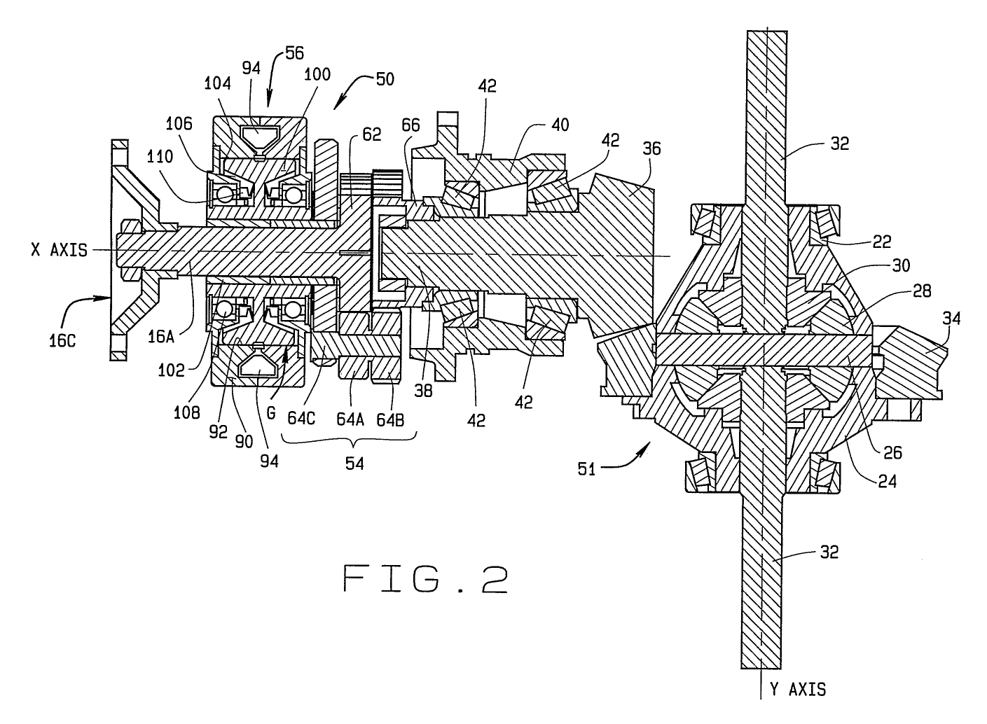

As illustrated in FIG. 2, the axle center assembly C consists of two main portions contained within an enclosed housing (not shown), a torque bias coupling 50 which receives driving torque from the drive shaft 16, and a conventional differential assembly 51 which is coupled to the output means of the torque bias coupling 50, and distributes the output torque to the rear wheels 4 of the vehicle A. The differential assembly 51 includes a pair of antifriction bearings 22 supporting a conventional differential carrier 24. The differential carrier 24 revolves about an axis Y, which is substantially coaxial with the rear axle of the vehicle A. The differential carrier 24 supports a cross shaft 26 on which a set of bevel gears 28 rotate. The bevel gears 28 engage additional bevel gears 30 which have the capacity to rotate within the differential carrier 24 itself, independently of each other. The bevel gears 30 are connected to opposing output shafts 32 which extend from the enclosing housing along the Y axis. The output shafts 32 may be connected to the axle shafts 18 of the rear axle by any conventional means, such as constant velocity (CV) joints, or they may be integrally formed directly with the ends of the axle shafts 18. The differential carrier 24 further includes an external ring gear 34 which engages a pinion 36 located on one end of a pinion shaft 38 disposed along an axis X which is substantially perpendicular to the Y axis. The pinion shaft 38 rotates within a pinion carrier 40, and is supported by a set of antifriction bearings 42.

The torque bias coupling 50 couples the drive shaft 16 with the pinion shaft 38. The torque bias coupling 50 is configured to modulate the torque transferred to the secondary wheels 4 through the pinion shaft 38 and the differential carrier 24, thereby apportioning the torque between the primary wheels 2 and the secondary wheels 4. As best seen in FIGS. 2 and 3, the torque bias coupling 50 comprises a housing 52 which is secured firmly to the pinion carrier 40 and to the enclosing differential housing (not shown). The toque bias coupling 50 includes a double planet planetary gear set 54 and a magnetic particle brake 56 located within the enclosing housing 52 where they are organized about the X-axis, coaxial with the axis of rotation for the pinion shaft 38. The torque bias coupling 50 provides torque transfer paths between the drive shaft 16 and the pinion shaft 38.

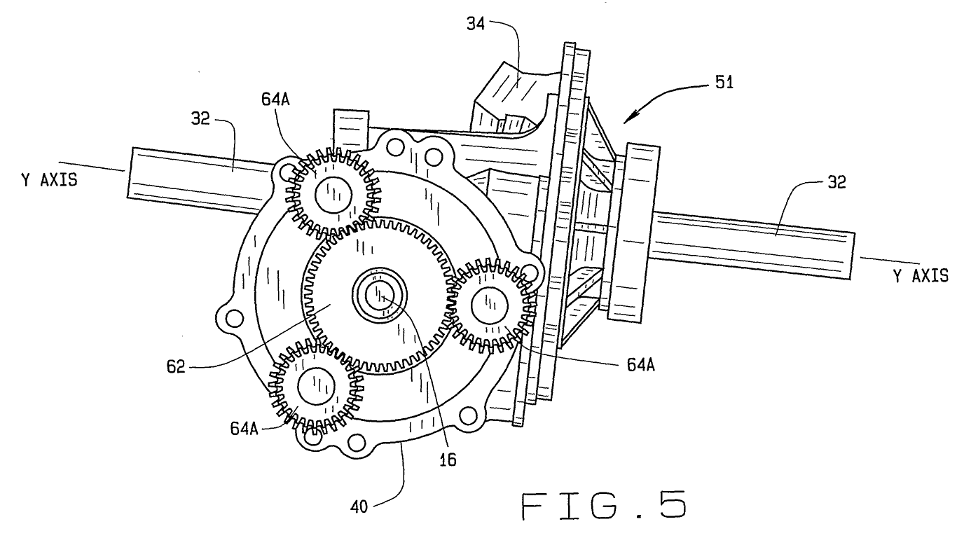

Within the torque bias coupling 50, the double planet planetary gear set 54 includes a first sun gear 62 having a shaft segment 16A acting as an input means which is operatively coupled to the drive shaft 16 by a suitable coupling 16C, and a double planet component 64. The double planet component 64 consists of a first planet gear 64A, and a second planet gear 64B having a different number of teeth, each coupled to a common carrier shaft 64C. The first and second planet gears 64A and 64B are rigidly connected and rotate together about the common carrier shaft 64C. A second sun gear 66 is connected to an output means, such as the pinion shaft 38, and has fewer teeth than the first sun gear 62. With the first planet gear 64A in engagement with the first sun gear 62, the second planet gear 64B is in engagement with the second sun gear 66, as best seen in FIGS. 3 and 5.

With this arrangement, torque can be transmitted from the drive shaft 16 to the pinion stem 38 (via the first sun gear 62, first and second planet gears 64A and 64B, and the second sun gear 66) only when a reaction force is provided to the planet carrier 64C, to slow or stop rotation thereof about the X-axis. Preferably the reaction force is provided by the magnetic particle brake 56 coupled to the axle housing 52 and which is operatively coupled to act on the planet carrier 64C as seen in FIGS. 2 and 3.

The magnetic particle brake 56 includes an electromagnet 90 which is secured to the axle housing 52, having a inner cylindrical surface 92 concentric about the X-axis. A coil 94 is disposed within the electromagnet 90, and is configured to receive a controlled flow of electrical current from an external control mechanism (not shown). An armature 100 having an outer cylindrical surface 104, is concentrically disposed between the X-axis and the cylindrical surface 92 on the electromagnet 90, such that there is a small gap G between the cylindrical surfaces 92 and 104. The armature 100 is coupled to the planetary carrier 64C of the planetary gear set 54, and is concentric about the drive shaft 16 through which torque is delivered to the torque bias coupling 50. Annular recesses 106 disposed in opposite axial faces of the armature 90, support antifriction bearings 108 circumferentially about a sleeve portion 102 of the armature 100. The electromagnet 90 is supported against radial movement about the X-axis by the antifriction bearings 108. As is known to those of ordinary skill in the art, the magnetic particle brake 56 contains fine particles of a ferrous substance which can be selectively magnetized and demagnetized, and which are disposed within the gap G between the electromagnet 90 and the armature 100. annular seals 110 isolate the fine particles within the gap G from the antifriction bearings 108.

When the coil 94 within the electromagnet 90 is energized by a flow of electrical current, the fine particles become magnetized and effectively couple the electromagnet 90 with the armature 100, such that torque can be transferred between the rotating armature and the stationary electromagnet, while allowing limited rotational slippage. The amount of torque transferred is proportional to the flow of electrical current conducted by the coil 94, and is independent of the magnitude of the slippage or the operating temperature of the magnetic brake 56.

During operation, engagement of the magnetic brake 56 slows or stops rotation of the planet carrier 64C about the X-axis to provide the required reaction force necessary to allow torque transmission between the drive shaft 16 and the pinion stem 38. The flow of electrical current directed through the coil 94 of the electromagnet 90 may be controlled by a variety of known control mechanisms. For example, the flow of electrical current may be regulated by a manually operated device such as a rheostat, or the flow of electrical current may be controlled by a microprocessor which derives signals from sensors that monitor various driving conditions of the vehicle A. These driving conditions may include vehicle speed, throttle position, forward and lateral accelerations, and steering wheel position, with the microprocessor directing the flow of electrical current to enable the vehicle A to operate in an optimum condition for a given set of parameters.

During operation of vehicle A, torque generated by the motor 6 is transferred throughout the transmission 8, which may alter it, to the transfer case or PTO 10, which splits it, delivering a portion to the primary wheels 2 and the remainder to the secondary wheels 4. The torque is preferably delivered to the primary wheels 2 without any slippage, passing from transfer case or PTO 10 to the differential 12 and thence to the wheels 2 through the axle shafts 14. The remaining torque which is delivered to the secondary wheels 4 passes from the transfer case or PTO 10 through the drive shaft 16 and thence through the axle center assembly C to the axle shafts 14, which deliver it to the wheels 4. The torque delivered to the primary wheels 2 together with the torque delivered to the secondary wheels 4, equals the total torque in the vehicle drive system, less of course any system losses, such as the torque lost through friction. The total torque is apportioned between the primary wheels 2 and the secondary wheels 4 by the torque bias coupling 50 of the axle center assembly C, with the apportionment being related to the flow of electric current passing through the coil 90 in the magnetic brake 56 of the torque bias coupling 50. The greater the flow of electrical current, the higher the proportion of torque transferred to the secondary wheels 4.

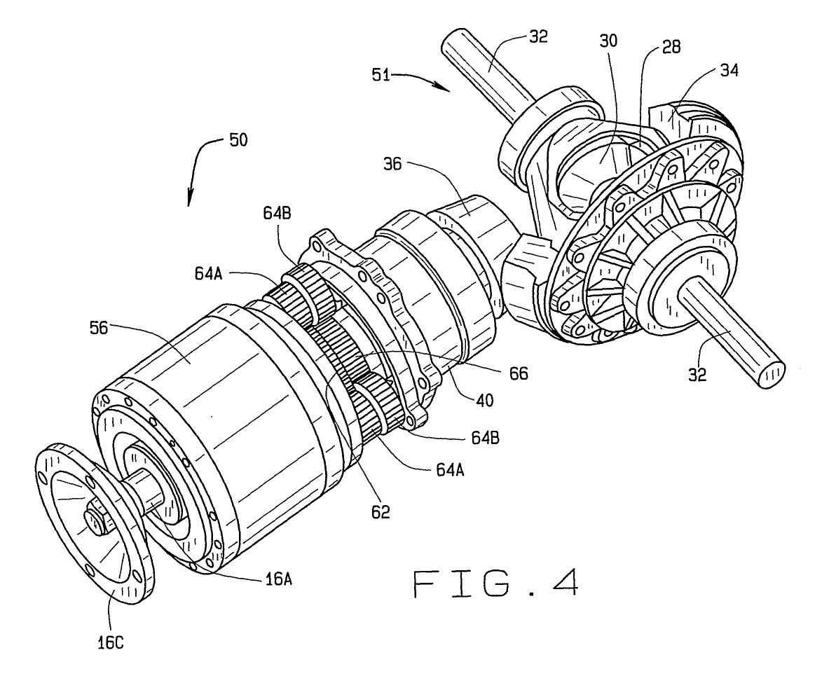

During operation of the torque bias coupling 50, it will be seen that the second sun gear 66, and correspondingly the pinion shaft 38, can be operated over a range of speeds which include an over-speed condition relative to the first sun gear 62 and drive shaft 16, by a specific RPM amount, up to 10% (for example) of the drive shaft normal rotational speed. This translates into an over-speed effect for the rear axle relative to the front axle of the vehicle A, which may be used in order to alter the vehicle driving dynamics. The number of teeth on the gears 62, 64A, and 64B in the planetary set 54 defines not only the speed ratio of the planetary gear set 54 and the available over-speed percentage for the rear axle, but also the operational requirements in terms of torque capacity for the magnetic particle brake 56 which acts on the planet carrier 64C. For example, to achieve a 10% over-speed effect, the amount of torque experienced by the magnetic brake 56 will represent only approximately 10% of the torque transmitted from the drive shaft 16 to the pinion stem 38 through the torque bias coupling 50. For a case in which 1000 Nm is delivered to the rear axle, the magnetic particle brake 56 must have a capacity in the relatively low range of 100 Nm, allowing for a compact design of the magnetic particle brake 56 and double-planet planetary gear set 54, as illustrated in FIG. 4.

When little or no electrical current flows to the coil 90 of the magnetic brake 56, little or no torque is transmitted through the drive shaft 16 to the pinion stem 38. Accordingly, a lesser amount of torque is diverted from the transfer case or PTO 10 to the secondary wheels 4, and a greater amount of torque is transferred to the primarily driving wheels 2. Conversely, when the flow of electrical current in the coil 90 of the magnetic brake 56 increases, the planetary components 64 transfer more torque which translates into a proportionally greater torque at the pinion 36. The greater demand for torque by the drive shaft 16 reduces the torque available for the primary drive wheels 2. Thus, the flow of electrical current passing through the coil 90 of the magnetic particle brake 56 determines the proportion of the total torque which is diverted through the torque bias coupling 50 and the torque delivered to the secondary wheels 4. The remaining torque from the transfer case or PTO 10 is directed to the primary wheels 2. In short, the flow of electrical current in the coil 90 of the magnetic particle brake 56 controls the division of torque between primary wheels 2 and the secondary wheels 4. The flow electrical current is the only required control parameter for the magnetic particle brake 56, resulting in a relationship between torque and the flow of electrical current which is nearly linear, and which affords good control.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. An improved axle center assembly for use in an automotive vehicle having a torque producing motor, a primary set of driving wheels, a secondary set of driving wheels, and a transmission operatively coupled between the sets of driving wheels and the torque-producing motor, the improved axle center assembly coupled between the motor and the secondary set of driving wheels to regulate torque distribution between the primary and secondary sets of driving wheels, the axle center comprising:
a torque bias coupling through which torque from the motor passes for distribution to the secondary set of driving wheels, said torque bias coupling including an input means operatively coupled to receive torque from the motor and an output means operatively coupled to deliver torque to said secondary set of driving wheels, said torque bias coupling further including a double-planet planetary gear set having first and second planet gears rigidly coupled together about a common planet carrier; and
a magnetic particle brake to regulate a transfer of torque between said input means and said output means, said magnetic particle brake configured to apply a reaction force on said common planet carrier.

2. The improved axle center assembly of claim 1 wherein said double-planet planetary gear set is configured to drive the secondary set of driving wheels in an over speed condition relative to the primary set of driving wheels.

3. The improved axle center assembly of claim 1 wherein said transfer of torque between said input means and said output means is regulated by a flow of electrical current within said magnetic particle brake.

4. The improved axle center assembly of claim 1 wherein the magnetic particle brake and said double-planet planetary gear set are organized about a common axis.

5. The improved axle center assembly of claim 4 wherein said double-planet planetary gear set further includes
a first sun gear coupled to said input means; a second sun gear coupled to said output means; and
a double-planet component having said first planet gear engaged with said first sun gear, and said second planet gear engaged with said second sun member.

6. The improved axle center assembly of claim 5 wherein said first sun gear has a greater number of teeth than said second sun gear; and
wherein said first planet gear has a smaller number of teeth than said second planet gear, such that said second sun gear can be driven in an over-speed condition relative to said first sun gear through application of said reaction force to said common planet carrier.

7. The improved axle center assembly of claim 1 wherein the axle center further includes a differential assembly operatively coupled to receive torque from said output means and to distribute said received torque to said secondary driving wheels.

8. (canceled)

9. (canceled)

10. (canceled)

11. The improved axle center assembly according to claim 7 wherein said output pinion and said differential assembly are enclosed within a first housing, and wherein said torque bias coupling is enclosed within a second housing coupled to said first housing.

12. The improved axle center assembly of claim 1 wherein said magnetic particle brake is configured to receive a flow of electrical current, and wherein said applied reaction force is proportional to said flow of electrical current.

13. The improved axle center assembly of claim 12 wherein said applied reaction force is linearly proportional to said flow of electrical current.

14. A torque bias coupling for selectively transferring torque from an input shaft to an output shaft, comprising:
a double-planet planetary gear set coupling the input shaft to the output shafts said double-planet planetary gear set including a first sun gear coupled to the input shaft, a second sun gear coupled to the output shaft, at least one first planet gear engaged with said first sun gear, and at least one second planet gear rigidly coupled to said at least one first planet gear on a planet carrier, said at least one second planet gear engaged with said second sun gear;
a brake mechanism operatively coupled to said planetary gear set, said brake mechanism configured to apply a rotational reaction force to said planet carrier of said planetary gear set; and
wherein said planetary gear set is responsive to said rotational reaction force to proportionally transfer torque from the input shaft to the output shaft.

15. (canceled)

16. (canceled)

17. The torque bias coupling of claim 14 wherein said planetary gear set is configured to rotationally drive the output shaft over a speed range which is greater than a speed range of the input shaft.

18. The torque bias coupling of claim 14 wherein said brake mechanism is a magnetic particle brake having a rotating armature coupled to said component of said planetary gear set, and a stationary electromagnet concentrically disposed about said armature and separated there from by an annular gap;
a distribution of selectively magnetizable particles disposed within said annular gap;
a coil is disposed within said electromagnet, said coil configured to receive a controlled flow of electrical current; and
wherein said magnetizable particles are magnetically responsive to said controlled flow of electrical current within said electromagnet to align within said gap and apply a reaction force between said stationary electromagnet and said rotating armature.

19. The torque bias coupling of claim 14 wherein said rotational reaction force applied by said brake mechanism is linearly responsive to a control signal.

20. The torque bias coupling of claim 19 wherein said control signal is a flow of electrical current to said brake mechanism.
